(19) United States
(12) Patent Application Publication
(10) Pub. No.: US 2020/0216337 A1
(43) Pub. Date: Jul. 9, 2020

(54) SULFATE REMOVAL OF WET AIR OXIDIZED SPENT CAUSTIC

(71) Applicant: Siemens Energy, Inc., Orlando, FL (US)

(72) Inventors: Bryan J. Kumfer, Ringle, WI (US); Bruce M. Schertz, Weston, WI (US); Alexis Schleusner, Kronenwetter, WI (US)

(21) Appl. No.: 16/638,562

(22) PCT Filed: Aug. 7, 2018
(86) PCT No.: PCT/US2018/045490

§ 371 Date: Feb. 12, 2020

Related U.S. Application Data
(60) Provisional application No. 62/545,197, filed on Aug. 14, 2017.

(51) Int. Cl. C02F 1/52; C02F 1/74

(52) U.S. Cl. CPC C02F 1/5245; C02F 2101/101; C02F 2209/06; C02F 1/74

(57) ABSTRACT

The present inventors have developed systems and processes that improve sulfate removal from a fluid stream (14), such as a wet air oxidation (WAO)-treated spent caustic.

### CROSS REFERENCE TO RELATED APPLICATIONS

This application claims priority to and the benefit of the filing date of U.S. Provisional Application No. 62/545,197, filed Aug. 14, 2017, the entirety of which is incorporated by reference herein.

### FIELD

The present disclosure relates generally to treatment systems and processes, and more particularly to systems and processes for removing sulfates from a fluid stream, such as a wet air oxidized (WAO)-treated spent caustic.

### BACKGROUND

Wet air oxidation (WAO) is a well-known technology for treating process streams and is widely used, for example, to destroy pollutants in wastewater. The process involves aqueous phase oxidation of undesirable constituents by an oxidizing agent, generally molecular oxygen from an oxygen-containing gas, at elevated temperatures and pressures relative to atmospheric conditions. In addition, the process can convert organic contaminants to carbon dioxide, water, and biodegradable short chain organic acids, such as acetic acid. Inorganic constituents including sulfides, mercaptides, and cyanides can also be oxidized. WAO may be used in a wide variety of applications to treat process streams for subsequent discharge, in-process recycle, or as a pre-treatment step for a conventional biological treatment plant.

In a particular application, wet air oxidation of spent caustics produces waste streams with high levels of sulfate. This is due to the conversion of sulfur species such as thiosulfate (S₂O₃²⁻), sulfite (SO₃²⁻), and sulfide (S²⁻) to sulfate (SO₄²⁻) during the WAO treatment process. Sulfate levels typically range from 3 to 15% by weight. Such sulfate levels are typically too high for discharge to biological treatment, discharge to a body of water, or for beneficial reuse. Depending on the end use of the water, sulfate levels may need to be reduced to <500 mg/L. Accordingly, WAO of such streams requires further treatment to reduce sulfate in the WAO-treated effluent below acceptable levels.

Current solutions for reducing sulfates include crystallizers, evaporation ponds, or dilution with a relatively cleaner fluid stream. These treatment options, however, are either costly, energy intensive, or impractical. For end use which requires <500 mg/L sulfate, dilution is not a viable option since dilution requires availability of a very large (clean) dilution fluid source to meet the desired limits. Further, crystallizers are expensive and evaporation ponds are becoming less common due to environmental issues. Accordingly, improved solutions are needed for reducing sulfate levels in fluid streams, such as WAO-treated spent caustics.

### BRIEF DESCRIPTION OF THE DRAWINGS

The invention is explained in the following description in view of the drawings that show:

FIG. 1 is a schematic of a sulfate removal system from a wet air oxidation (WAO)-treated spent caustic in accordance with an aspect of the present invention.

### DETAILED DESCRIPTION

The present inventors have developed systems and methods for efficiently and inexpensively removing sulfates from a sulfate-containing stream. In an embodiment, the sulfate-containing stream comprises a spent caustic which has been subjected to a wet air oxidation (WAO) process to produce a quantity of sulfates in the fluid stream. In one aspect, the systems and processes described herein are significantly less expensive than commonly used crystallizers and evaporation ponds. Further, the solutions described herein eliminate the requirement for large amounts of clean dilution water that would be required to lower sulfate concentrations below acceptable levels. Moreover, the solutions provided herein do not require significant materials and do not add any significant waste volume.

In accordance with an aspect of the present disclosure, there is provided a treatment process comprising:

a) subjecting a fluid stream comprising sulfidic compounds to wet air oxidation to generate a first treated stream comprising an amount of sulfates therein;

b) contacting the first treated stream with an amount of a calcium compound while maintaining a pH of about 12 or less to precipitate an amount of calcium sulfate in the first treated stream;

c) removing at least a portion of the precipitated calcium sulfate from the first treated stream to generate a second treated stream;

d) contacting the second treated stream with an amount of an aluminum compound effective to precipitate a calcium-aluminum-sulfate compound; and

e) removing at least a portion of the precipitated calcium-aluminum-sulfate compound from the second treated stream to generate a third treated stream having a sulfate concentration less than a predetermined value.

In accordance with another aspect, there is provided a treatment process comprising:

a) subjecting a sulfidic spent caustic to wet air oxidation to generate a first treated stream comprising an amount of sulfates therein;

b) contacting the first treated stream with an amount of a calcium compound effective to precipitate an amount of calcium sulfate in the first treated stream, wherein the contacting with the calcium compound while maintaining a pH of the first treated stream at about 12 or less;

c) removing at least a portion of the precipitated calcium sulfate from the first treated stream to generate a second treated stream;

d) contacting the second treated stream with an amount of an aluminum compound effective to precipitate ettringite; and

e) removing at least a portion of the precipitated ettringite from the second treated stream to generate a third treated stream having a sulfate concentration at or below a predetermined value.

In accordance with yet another aspect, there is provided a treatment system comprising:

a) a source of a fluid stream comprising sulfidic compounds;

b) a wet air oxidation unit in fluid communication with the source of the fluid stream, the wet air oxidation unit configured to oxidize an amount of sulfidic compounds in the fluid stream and generate a first treated stream comprising sulfates therein;

c) a vessel in fluid communication with the wet air oxidation unit and configured to receive the first treated stream from the wet air oxidation unit;

d) a source of a calcium compound configured to deliver calcium to a location of the first treated stream in order to precipitate calcium sulfate from the first treated stream;

e) a liquid/solid separator configured to remove at least a portion of the calcium sulfate precipitate from the first treated stream;

f) a source of an aluminum compound configured to deliver aluminum to a location of the second treated stream to precipitate a calcium-aluminum-sulfate compound from the second treated stream; and wherein the liquid/solid separator or an additional liquid/solid separator is configured to remove at least a portion of the precipitated calcium-aluminum-sulfate compound from the second treated stream to produce a third treated stream having a sulfate concentration at or below a predetermined value.

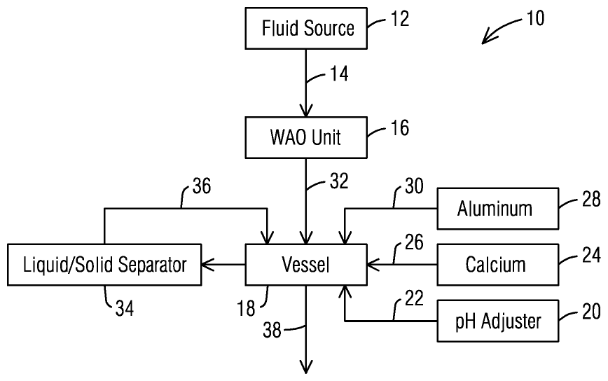

Now referring to the figures, FIG. 1 illustrates a system 10 for removing sulfates from a fluid stream in accordance with an aspect of the present invention. The system 10 includes a source 12 of a fluid 14 comprising sulfidic compounds (which are capable of being oxidized to sulfate compounds), a wet air oxidation (WAO) unit 16 in fluid communication with the source 12, and one or more vessels 18 in fluid communication with the WAO unit 16. In addition, a source 20 of a pH adjuster 22, a source 24 of a calcium-containing compound (calcium compound) 26, and a source 28 of an aluminum-containing compound 30 are provided to provide necessary materials to the relevant fluid streams to facilitate precipitated of the desired species as will be provided below. For ease of viewing, the materials 22, 26, 30 are illustrated as being delivered to a single vessel, e.g., vessel 18, however, it is understood that the present invention is not so limited. In some instances, the materials may be delivered to distinct vessels. Further, it is appreciated that the system 10 includes suitable structure(s) (liquid/solid separator or separator 34) to facilitate the liquid/solid separation of the calcium sulfate and calcium-aluminum-sulfate precipitates from their respective fluid streams.

The fluid 14 may comprise any aqueous-based fluid comprising a plurality of sulfur-containing compounds—at least some of which are capable of being oxidized via a wet air oxidation process to a plurality of sulfate compounds. In an embodiment, the fluid 14 comprises a spent caustic, and in particular, a WAO-treated spent caustic. For example, the spent caustic may comprise a refinery spent caustic or a sulfidic spent caustic as is known in the art that has been subjected to a wet air oxidation (WAO) process as described herein.

As used herein, the term “refinery spent caustic” refers to spent caustic generated in the operation of equipment and processes such as those which may be found at a petroleum refinery. Refinery spent caustic may have high levels of chemical oxygen demand (COD), in some cases between about 400,000 mg/L and 500,000 mg/L or more. Refinery spent caustic may contain one or more of naphthenic spent caustics or cresylic spent caustics. As used herein, the term “about” refers to a value which is ±1% of the stated value.

Naphthenic spent caustics may be produced from the scrubbing of kerosene and jet fuels and may contain high concentrations of organic compounds consisting of naphthenic acids, and also may contain phenol compounds and reduced sulfur compounds. Naphthenic spent caustics may also contain high levels of chemical oxygen demand (COD), in some cases greater than 100,000 mg/L. Naphthenic spent caustics may also contain thiosulfates and naphthenic acids, which may be broken down in a wet air oxidation process at temperatures above about 220° C. to about 280° C. or higher. Cresylic spent caustics may be produced from the scrubbing of gasoline and may contain high concentrations of phenol compounds (cresylic acids) and may also contain reduced sulfur compounds.

In another embodiment, the fluid 14 may comprise a sulfidic spent caustic. Sulfidic spent caustics may be produced from the scrubbing of hydrocarbons and may contain high concentrations of reduced sulfur compounds, such as sulfides and mercaptans, as well as organic carbon concentrations.

In a particular embodiment, the sulfidic spent caustic comprises an ethylene spent caustic. The term “ethylene spent caustic” refers to spent caustic generated in the operation of equipment and processes such as those which may be found at an ethylene production facility, e.g., caustic used in the scrubbing of ethylene. For example, ethylene spent caustic may come from the caustic scrubbing of cracked gas from an ethylene cracker. This liquor may be produced by a caustic scrubbing tower. Ethylene product gas may be contaminated with H₂S(g) and CO₂(g), and those contaminants may be removed by absorption in a caustic scrubbing tower to produce NaHS(aq) and Na₂CO₃(aq). The sodium hydroxide may be consumed and the resulting wastewater (ethylene spent caustic) contaminated with the sulfides, carbonates, and a small fraction of organic compounds. Insoluble polymers resulting from the condensation of olefins during scrubbing may also be present. Further examples of spent caustic comprising sulfidic compounds capable of being oxidized to sulfates are set forth in U.S. Pat. No. 9,630,867, the entirety of which is hereby incorporated by reference.

As mentioned, from the fluid source 12, the fluid 14 is delivered to the WAO unit (or system) 16. The WAO unit 16 may comprise one or dedicated vessels formed a suitable inert material for carrying out the subject oxidation reactions. Within the WAO unit 16, the fluid is subjected to wet air oxidation (“WAO”). WAO is an aqueous phase oxidation process using molecular oxygen contained in air (or any other oxygen containing gas) as an oxidant. The process may operate at elevated temperatures and pressure relative to atmospheric conditions. For example, some WAO systems may operate at temperatures and pressures which may range from about 120° C. (248° F.) to 320° C. (608° F.) and 760 kPa (110 psig) to 21,000 kPa (3000 psig), respectively. The utilization of higher treatment temperatures may reduce the amount of time required for a desired level of treatment.

In some embodiments, the pressure of the WAO unit 16 may be controlled to a specific set point, and in other embodiments the pressure of the WAO unit 16 may attain a certain level as a result of the heating of the fluid being treated and the atmosphere within the WAO unit 16. In other embodiments, the fluid to be treated (fluid 14) is pumped up to pressure by a high pressure feed pump. A gas stream, such as air, containing sufficient oxygen to meet the oxygen demand requirements of the waste stream (fluid 14) may then be injected into the pressurized waste stream, and the air/liquid mixture may be preheated to the desired reactor inlet temperature. The mixture may then be introduced into a vessel of the WAO unit 16 where the majority of oxidation may take place. Alternatively, or in addition, oxygen containing gas may also be injected directly into the WAO unit 16. Some WAO systems also include subsystems allowing the pH of the fluid to be treated to be adjusted. A pH adjuster, such as an acid or a base, may be added to the stream to be treated before introduction into the WAO unit 16, or into the WAO unit 16 itself.

The WAO unit 16 may provide sufficient retention time to allow the oxidation to approach a desired reduction in COD and production of sulfates. Oxidation reactions, being exothermic, typically produce a temperature rise in the WAO unit 16, making the reactor outlet temperature higher than the inlet temperature. This temperature differential may allow for the recovery of heat from the hot reactor effluent. The hot reactor effluent may be used, for example, to preheat the feed to the reactor.

In some cases, there is more thermal energy available than is required for preheating the reactor feed (fluid 14). Even after heating the reactor feed, therefore, the reactor effluent may still require cooling before discharge. After cooling, the pressure of the reactor effluent stream may be reduced and separated into vapor and liquid phases. The liquid phase may be transferred or discharged to a further treatment system, such as the sulfate reduction systems and processes disclosed herein. The vapor phase may be further treatment or released to the environment.

In any case, the fluid 14 (e.g., spent caustic) is subjected to wet air oxidation for a time and under conditions effective to oxidize components therein to a desired degree and, in this instance, produce a first treated stream 32 comprising at least an amount of sulfate compounds therein. In certain embodiments, the sulfate level in the first treated stream 32 may be determined in situ by a suitable device or method. If the sulfate levels are greater than 500 mg/L, then it is typically necessary that the first treated stream 32 be further treated to reduce sulfate levels for biological treatment, discharge, or reuse of the same. In such case, the first treated stream 32 is delivered from an outlet of the WAO unit 16 to a vessel 18 to begin reduction of sulfate levels of the first treated stream 32. In an embodiment, the first treated stream 32 comprises a sulfate concentration of from about 3 to about 15% by weight. In addition, in certain embodiments, the first treated stream 32 may be passed through a heat exchanger to warm incoming feed stream to the WAO unit 16 prior to delivery of the first treated stream to the vessel 18. Within the vessel 18, a first precipitation step is initiated by introducing an effective amount of a calcium compound 26 from the calcium compound source 24 to the vessel 18 to precipitate an amount of calcium sulfate. As used herein also, the term “effective amount” refers to an amount needed to bring about a desired result. In an embodiment, the effective amount of calcium provided to be introduced is determined by measuring an amount of sulfate in the first treated stream 32. In some embodiment, the measuring is done continuously throughout the calcium sulfate precipitation process. The amount of calcium compound 26 added to the first treated stream 32 corresponds to the measured amount of sulfate in the treated stream 32. In certain embodiments, the amount of calcium introduced is a stoichiometric amount.

The calcium compound may be any suitable calcium-containing compound which is capable of reacting with a sulfate in the first treated stream 32 to produce calcium sulfate. In an embodiment, the calcium compound comprises calcium oxide, calcium hydroxide, calcium chloride, or combinations thereof. In certain embodiments, the calcium sulfate precipitation reaction in the vessel 18 is allowed to continue to completion or near completion. For example, in some embodiments, the calcium sulfate reaction continues until a free sulfate concentration in the first treated stream 32 in the vessel 18 decreases below a predetermined value and/or substantially plateaus (e.g., records concentration values that are within a 5 percent range of one another over a predetermined time interval, e.g., 5 minutes). In some embodiments, the first treated stream 32 is contacted with the calcium compound 26 for a duration of from about 5 minutes to about 300 minutes, and in particular embodiment from about 5 to about 100 minutes. Further, in certain embodiments, the temperature may be elevated to promote the precipitation of calcium sulfate. In an embodiment, the precipitation is carried out a temperature of from about 10 to about 90° C., and in a particular embodiment from about 40 to about 50° C.

Once formed, the solid calcium sulfate precipitate may be removed from the first treated stream 32 by any suitable solid/liquid separation process or apparatus (solid/liquid separator 34″) known in the art. In some embodiments, the separation may take place in the vessel 18 or at least a portion of the contents of the first treated stream 32 may be transferred to a distinct vessel to remove at least a portion of the calcium sulfate precipitate, thereby leaving behind a second treated stream 36 having a reduced sulfate content relative to the first treated stream 32 and precipitated solids, which may be directed to storage, disposal, transport, or the like. Without limitation, the solid/liquid separator 34 may comprise one of a clarifier, a belt press, and a hydrocyclone.

FIG. 1 illustrates the solid/liquid separator 34 as a distinct component from vessel 18, but it is appreciated that the solid/liquid separator 34 may also be incorporated or otherwise associated with the vessel 18. Once the separation process is completed, the resulting second treated stream 36 may be subjected to an aluminum-based precipitation process to further remove sulfates from the second treated stream, thereby generating a third treated stream 38 having a sulfate concentration at or less than a predetermined value.

To further remove the sulfates from the second treated stream 36, the second treated stream 36 is contacted with an aluminum-containing compound (“aluminum compound 30”) in a secondary precipitation step for an amount of time effective to precipitate one or more calcium-aluminum-sulfate compounds from the second treated stream 36. To accomplish this, the aluminum compound 30 may be delivered from a suitable aluminum source 28 to the vessel 18 (or other vessel) containing the second treated stream 36. The aluminum compound 30 may comprise any Al-containing compound which when contacted with the second treated stream 36 precipitates the calcium-aluminum-sulfate compound. The calcium for the calcium-aluminum-sulfate compound precipitation may be an amount remaining in the stream 36 from calcium sulfate precipitation, or may further include added calcium compound 26 as set forth below. In an embodiment, the pH of the second treated stream 26 during calcium-aluminum-sulfate precipitation is maintained at a range of from 10.5 to 12.5, and in a particular embodiment from about 11.2 to about 12.2.

In addition to the aluminum compound, in certain embodiments, an additional amount of calcium compound 26 (beyond what was added to the first treated stream 32) may be added from the calcium source 24 to the second treated stream 36 to assist in precipitating the one or more calcium-aluminum-sulfate compounds from the second treated stream 36. The additional calcium compound 26 may likewise comprises calcium oxide, calcium hydroxide, calcium chloride, or combinations thereof. In addition to supplying calcium for the secondary precipitation, the additional calcium compound 26 may also aid in controlling the pH during the secondary precipitation step. In certain embodiments, the pH of the second treated stream 36 is lowered during secondary precipitation of the one or more calcium-aluminum-sulfate compounds (e.g., ettringite). The additional calcium compound 26 may thus be utilized to maintain the pH of the second treated stream 26 during calcium-aluminum-sulfate precipitation at the range of from 10.5 to 12.5, and in a particular embodiment from about 11.2 to about 12.2. In certain embodiments, significantly less calcium (e.g., <50% by wt) is utilized in the secondary precipitation step relative to the primary calcium sulfate precipitation step.

In an embodiment, the Al-containing compound may comprise aluminum hydroxide Al(OH)₃. In certain embodiments, the calcium-aluminum-sulfate compound precipitated by the secondary precipitation step comprises ettringite, which is a hydrous calcium aluminum sulfate mineral with formula: Ca₆Al₂(SO₄)₃(OH)₁₂.26H₂O. It is understood, however, that other solids may be formed in the process which comprises sulfate, and thus assists in removal of sulfate from the second treated stream 36. In certain embodiments, the aluminum-based secondary precipitation step is carried it for a duration of from 1 to 300 minutes depending on the degree of sulfate removal required.

Once a desired level of the Al-based precipitation has occurred (and similar to the first precipitation with a calcium compound), the second treated stream 36 with the precipitated calcium-aluminum-sulfate compound may be subjected to or otherwise introduced to a liquid/solid separator 34 to separate the precipitated calcium-aluminum-sulfate compound from the second treated stream 36, thereby generating a third treated stream 38 having a sulfate concentration at or less than a predetermined value. In an embodiment, the predetermined value is about 500 mg/L or less. In certain embodiments, the solid/liquid separator 34 for the calcium-based precipitation step and the solid/liquid separator 34 for the aluminum-based precipitation step may comprise the same structure. In other embodiments, they may comprise separate structures.

In accordance with an aspect, the present inventors have surprisingly found that if the pH of the above-described calcium-based precipitation process is not maintained at pH of about 12 or less, the degree of sulfate removal by the primary (Ca-based) and secondary (Al-based) precipitation steps will be inadequate and will not reduce sulfate levels below acceptable levels, e.g., 500 mg/L, following the two separation/precipitation techniques. For example, the inventors have found that, in some instances, if no pH adjustment at all is provided during calcium addition/precipitation, only about 6% by weight of the sulfate is removed—even after the secondary aluminum precipitation step—from the stream 34 (WAO-treated spent caustic).

Conversely, the present inventors have found that maintaining the pH at value at or below a pH of 12 during the calcium precipitation step significantly enhances sulfate recovery from the stream and efficiently produces a substantially sulfate-free treated stream suitable for further biological treatment, reuse, and/or discharge. Accordingly, in an aspect of the present disclosure, an effective amount of a pH adjuster 22 is added to the first treated stream 32 as needed during the precipitation of calcium sulfate. In an embodiment, the pH adjuster is added to the first treated stream 32 in the vessel 18 to maintain the pH at 12 or less during the calcium precipitation step. In an embodiment, the pH is maintained at a pH of from about 8 to about 12, and in a particular embodiment at pH of about 11 to about 12 during the calcium precipitation step. In this way, the precipitation of calcium sulfate is allowed to take and the first treated stream 32 is also prepared for the subsequent aluminum-based precipitation step, which preferably takes place at a pH of about 10.5 to about 12.5.

The pH adjuster 22 may be any suitable compound for maintaining the pH at the stated level. In an embodiment, the pH adjuster 22 is selected from the group consisting of carbon dioxide, an inorganic acid, such as HCl, or an organic acid, such as acetic acid. In certain embodiments, one or more pH sensors may be provided in the vessel to monitor the pH of the first treated stream 32 during the calcium sulfate precipitation step. In certain embodiments, a controller may be provided in electrical communication with the source 20 of the pH adjuster 22 to regulate the flow of the same to the first treated stream 32.

In the systems and processes described herein, it is appreciated that one or more inlets, pathways, outlets, mixers, pumps, valves, coolers, energy sources, flow sensors, or controllers (comprising a microprocessor and a memory), or the like may be included in any of the systems described herein for facilitating the introduction, output, timing, volume, selection, and direction of flow of any of the components or materials set forth therein. Moreover, the skilled artisan would understand the volumes, flow rates, concentrations, and other parameters necessary to achieve the desired result(s) can be determined by known processes.

The function and advantages of these and other embodiments of the present invention will be more fully understood from the following examples. These examples are intended to be illustrative in nature and are not considered to be limiting the scope of the invention.

### Example

Sulfate Removal - Precipitation (all samples 258 ml, unless noted)

| Sample | CaO | Al(OH)3 | SO4-S | SO4 | |
|---|---|---|---|---|---|
| Description | Added g | Added (g) | (mg/L) | (mg/L) | end pH |
| CaO addition | | | | | |
| WAO treated sulfidic spent | 0 | NA | 9940 | 29820 | |
| caustic Feed (initial ph 7.7) | | | | | |
| No pH adjustment | 8 | NA | 9341 | 28024 | 13.1 |
| Maintained pH between 8.4-9.1 | 8 | NA | 578 | 1733 | 8.75 |
| during test | | | | | |
| Maintained pH between 10.5-11 | 8 | NA | 501 | 1504 | 10.9 |
| during test | | | | | |
| Maintained pH between 11.5-12 | 8 | NA | 537 | 1611 | 11.9 |
| during test | | | | | |
| Al(OH)3 addition | | | | | |
| 0.151 g Al(OH)3 added to 3030- | 0.2 | 0.151 | <6.67 | <20 | 11.7 |
| 56-02 (100 ml of sample used), | | | | | |
| pH maintained between 11.2- | | | | | |
| 11.8 with CaO | | | | | |
| 0.131 g Al(OH)3 added to 3030- | 0.2 | 0.131 | 121 | 362 | 11.7 |
| 56-04 (100 ml of sample used), | | | | | |
| pH maintained between 11.2- | | | | | |
| 11.8 with CaO | | | | | |

The above table illustrates the effectiveness of controlling pH during a first (primary) calcium sulfate precipitation step (with CaO addition) to enable further sulfate removal in a subsequent (secondary) precipitation step (with Al(OH)₃ addition) and improved sulfate removal effectiveness overall. As can be seen, controlling the pH during calcium-based precipitation dramatically improved sulfate removal relative to no pH adjustment and that a further Al(OH)₃ sulfate removal step further improved sulfate removal below typical acceptable values (<500 mg/L).

Numerous variations, changes and substitutions may be made without departing from the invention herein. Accordingly, it is intended that the invention be limited only by the spirit and scope of the appended claims.

What is claimed is:

1. A treatment process comprising:
subjecting a fluid stream (14) comprising sulfidic compounds to wet air oxidation to generate a first treated stream (32) comprising an amount of sulfates therein;
contacting the first treated stream (32) with an amount of a calcium compound (26) while maintaining a pH of 12 or less to precipitate an amount of calcium sulfate in the first treated stream (32);
removing at least a portion of the precipitated calcium sulfate from the first treated stream (32) to generate a second treated stream (36);
contacting the second treated stream (36) with an amount of an aluminum compound (30) effective to precipitate a calcium-aluminum-sulfate compound; and
removing a portion of the precipitated calcium-aluminum-sulfate compound from the second treated stream (36) to generate a third treated stream (38) having a sulfate concentration less than a predetermined value.

2. The process of claim 1, wherein the fluid stream (14) comprises a spent caustic comprising the sulfidic compounds.

3. (canceled)

4. The treatment process of claim 1, wherein the predetermined value is 500 mg/L.

5. The treatment process of claim 1, wherein the first treated stream (32) comprises a sulfate concentration of from 3 to 15% by weight.

6. The treatment process of claim 1, wherein the calcium compound (26) is selected from the group consisting of calcium oxide, calcium hydroxide, calcium chloride, and combinations thereof.

7. The treatment process of claim 1, wherein the aluminum compound (30) comprises aluminum hydroxide.

8. The treatment process of claim 1, wherein the calcium-aluminum-sulfate compound comprises ettringite.

9. (canceled)

10. The process of claim 1, wherein the contacting the first treated stream with an amount of a calcium compound (26) is done at a temperature of from 10° C. to 90° C.

11. The process of claim 1, wherein the contacting the first treated stream (32) with an amount of a calcium compound (26) is done for a duration of from 10 to 300 minutes.

12. The process of claim 1, wherein the pH is maintained at 8 to 12.

13. The process of claim 12, wherein the pH is maintained at 11 to 12.

14. (canceled)

15. (canceled)

16. The process of claim 1, further comprising contacting the second treated stream (32) with an additional amount of the carbon compound (26) from the calcium compound (26) for the calcium sulfate precipitation, the additional calcium compound (26) effective to precipitate a calcium-aluminum-sulfate compound.

17. The process of claim 16, further comprising maintaining a pH of the second treated stream (32) at a pH of from 10.5 to 12.5 during the contacting of the second treated stream (32) with the aluminum compound (30).

18. The process of claim 17, further comprising maintaining a pH of the second treated stream (36) at a pH of from 11.2 to 12.2 during the contacting of the second treated stream (36) with the aluminum compound (30).

19. The process of claim 17, wherein the maintaining the pH of the second treated stream (36) is done via addition of the calcium compound (26) to the second treated stream (36).

20. A treatment process comprising:
subjecting a sulfidic spent caustic (14) to wet air oxidation to generate a first treated stream (32) comprising an amount of sulfates therein;
contacting the first treated stream (32) with an amount of a calcium compound (26) effective to precipitate an amount of calcium sulfate in the first treated stream (32), wherein the contacting the first treated stream (32) is done while maintaining a pH of the first treated stream (32) at 12 or less;
removing a portion of the precipitated calcium sulfate from the first treated stream (32) to generate a second treated stream (36);
contacting the second treated stream (36) with an amount of an aluminum compound and an additional amount of the calcium compound effective to precipitate ettringite, wherein the contacting the second treated stream (32) is done while maintaining a pH of the second treated stream (36) at a pH of 10.5 to 12.5; and
removing a portion of the precipitated ettringite from the second treated stream (36) to generate a third treated stream (38) having a sulfate concentration at or below a predetermined value.

21. The process of claim 20, wherein the contacting the first treated stream (32) is done while maintaining a pH of the first treated stream (32) at a pH of 8 to 12, and wherein the contacting the second treated stream (36) is done while maintaining the pH of the second treated stream (36) at a pH of from 11.2 to 12.2.

22. A treatment system (10) comprising:
a source of a fluid stream (14) comprising sulfidic compounds;
a wet air oxidation unit (16) in fluid communication with the source (12) of the fluid stream, the wet air oxidation unit (16) configured to oxidize an amount of sulfidic compounds in the fluid stream (14) and generate a first treated stream (32) comprising sulfates therein;
a vessel (18) in fluid communication with the wet air oxidation unit and configured to receive the first treated stream (32) from the wet air oxidation unit (16);
a source (24) of a calcium compound (26) configured to deliver calcium to a location of the first treated stream (32) in order to precipitate calcium sulfate from the first treated stream (32);
a liquid/solid separator (34) configured to remove at least a portion of the calcium sulfate precipitate from the first treated stream (32);
a source (28) of an aluminum compound (30) configured to deliver aluminum to a location of the second treated stream (36) to precipitate a calcium-aluminum-sulfate compound from the second treated stream (36); and
wherein the liquid/solid separator (34) or an additional liquid/solid separator (34) is configured to remove a portion of the precipitated calcium-aluminum-sulfate compound from the second treated stream (36) to produce a third treated stream (38) having a sulfate concentration at or below a predetermined value.

23. The system (10) of claim 22, further comprising a source (20) of a pH adjuster (22) in fluid communication with the vessel (18), the pH adjuster selected from the group consisting of carbon dioxide, hydrochloric acid, an organic acid, and combinations thereof to a vessel comprising the first treated stream.

24. The system (10) of claim 22, wherein the predetermined value is 500 mg/L.

25. The system (10) of claim 22, wherein the first treated stream (32) comprises a sulfate concentration of from 3 to 15% by weight.

26. The system (10) of claim 22, wherein the calcium compound (26) is selected from the group consisting of calcium oxide, calcium hydroxide, calcium chloride, and combinations thereof.

27. The system (10) of claim 22, wherein the aluminum compound (30) comprises aluminum hydroxide.

28. The system (10) of claim 22, wherein the calcium-aluminum-sulfate compound comprises ettringite.
